(19) United States
(12) Patent Application Publication
(10) Pub. No.: US 2025/0245123 A1
(43) Pub. Date: Jul. 31, 2025

(54) HYBRID TECHNIQUE FOR EARLY RISK MITIGATION OF PLATFORM SOFTWARE MIGRATION

(71) Applicant: Qorvo US, Inc., Greensboro, NC (US)

(72) Inventors: Paul Bricketto, High Point, NC (US); Suryanarayana Pappu, Gilbert, AZ (US)

(21) Appl. No.: 18/853,816

(22) PCT Filed: May 15, 2023
(86) PCT No.: PCT/US2023/022212

§ 371 Date: Oct. 3, 2024

Related U.S. Application Data
(60) Provisional application No. 63/345,146, filed on May 24, 2022.

(51) Int. Cl. G06F 11/3604

(52) U.S. Cl. CPC G06F 11/3608

(57) ABSTRACT

Systems and methods for a hybrid technique for risk mitigation of platform software migration are provided. In some embodiments, a method for mitigating risk of platform software changes includes one or more of: detecting change using static code analysis; and detecting dynamic/runtime behavioral changes. In some embodiments, early detection of code base migration issues (long before the actual hardware availability) reduces OEM resource requirements for solving software integration issues. Since OEMs have NDAs with platform providers that prohibit OEMs from sharing material with third parties, some embodiments of the current disclosure allow solving platform code base migration issues early during software integration in the OEM environment without having access to a vast majority of the code base; and/or without the luxury of actually being able to see/touch the problem.

### RELATED APPLICATIONS

This application claims the benefit of provisional patent application Ser. No. 63/345,146, filed May 24, 2022, the disclosure of which is hereby incorporated herein by reference in its entirety.

### FIELD OF THE DISCLOSURE

The present disclosure relates generally to the field of software validation.

### BACKGROUND

During the lifecycle of a product, Original Equipment Manufacturers (OEMs) receive several codebase updates from the platform provider. Often, such updates involve changes to third party deliverables due to changes in interfaces. With increasing complexity of platform software and Radio Frequency (RF) Front End (RFFE) components, OEMs are growing wary of the risks to third party software posed by codebase updates from platform vendors. Some of these updates are known to take place Over the Air (OTA), even after the product is launched. OEMs are usually constrained by a Nondisclosure Agreement (NDA) with platform providers and are unable to share the changed files with third parties. This causes them to wait until after the boards are built to call upon third parties to fix codebase migration issues. This has the potential to put critical milestones at risk.

Improved systems and methods for mitigating risk of platform software changes are needed.

### SUMMARY

Systems and methods for a hybrid technique for risk mitigation of platform software migration are provided. In some embodiments, a method for mitigating risk of platform software changes includes one or more of: detecting change using static code analysis; and detecting dynamic/runtime behavioral changes. In some embodiments, early detection of code base migration issues (long before the actual hardware availability) reduces Original Equipment Manufacturer (OEM) resource requirements for solving software integration issues. Since OEMs have Nondisclosure Agreements (NDAs) with platform providers (e.g., a chipset provider) that prohibit OEMs from sharing material with third parties, some embodiments of the current disclosure allow solving platform code base migration issues early during software integration in the OEM environment perhaps without having access to a vast majority of the code base; and/or without the luxury of actually being able to see/touch the problem.

In some embodiments, detecting dynamic/runtime behavioral changes includes: testing dynamic/runtime behavioral changes based on the detected change using static code analysis. In some embodiments, detecting dynamic/runtime behavioral changes includes: exercising the existing codebase and capturing the results; exercising the updated codebase and capturing the results; and comparing the captured results.

Those skilled in the art will appreciate the scope of the present disclosure and realize additional aspects thereof after reading the following detailed description of the preferred embodiments in association with the accompanying drawing figures.

### BRIEF DESCRIPTION OF THE DRAWING FIGURES

The accompanying drawing figures incorporated in and forming a part of this specification illustrate several aspects of the disclosure, and together with the description serve to explain the principles of the disclosure.

FIG. 1 illustrates a typical situation where a new software codebase is ported by the Original Equipment Manufacturers (OEMs).

FIG. 2 illustrates the updated cycle using the disclosed methods. Now the OEM runs the hybrid technique to determine the third party impact, according to some embodiments of the current disclosure.

FIG. 3 illustrates an example embodiment for mitigating risk of platform software changes, according to some embodiments of the current disclosure.

FIG. 4 illustrates additional details regarding the proposed methods, according to some embodiments of the current disclosure.

FIG. 5 is a block diagram of a system suitable for implementing examples according to one example.

### DETAILED DESCRIPTION

The embodiments set forth below represent the necessary information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure and the accompanying claims.

As discussed above, during the lifecycle of a product, Original Equipment Manufacturers (OEMs) receive several codebase updates from the platform provider. Often, such updates involve changes to third party deliverables due to changes in interfaces. With increasing complexity of platform software and Radio Frequency (RF) Front End (RFFE) components, OEMs are growing wary of the risks to third party software posed by codebase updates from platform vendors. Some of these updates are known to take place Over the Air (OTA), even after the product is launched. OEMs are usually constrained by a Nondisclosure Agreement (NDA) with platform providers and are unable to share the changed files with third parties. This causes them to wait until after the boards are built to call upon third parties to fix codebase migration issues. This has the potential to put critical milestones at risk. OEMs often cite this as a big risk factor in selecting third party components. As such, OEMs to continue to use to platform provided reference designs. This risk has the potential to result in design losses.

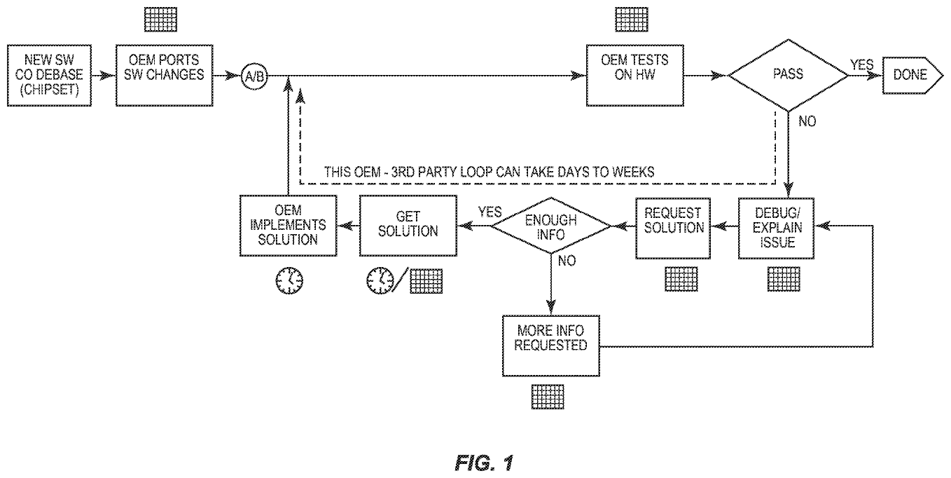

FIG. 1 illustrates a typical situation where a new software codebase is ported by the OEMs. As illustrated by the calendar symbol, this might take a long time. The OEM tests the new software on the hardware and if it passes, the process is done. However, if the tests are not passed, the system is debugged while the issue is explained, and a solution is requested. If the RFFE vendor does not have enough information, more information is requested. This process can take a significant amount of time. Even if enough information is provided, the solution must be provided and implemented. The testing cycle is then repeated. These steps take a significant amount of time.

RFFE vendors are heavily engaged with many OEMs around the globe, designing and integrating Software drivers in support of many different Front End (FE) components (e.g., Power Amplifier (PA), Low-Noise Amplifier (LNA), Antenna Switch Module (ASM), Tuner, LNA and Power Amplifier with Integrated Diplexer (LPAMiD)) on different platforms. Deliverables range from source code to platform agnostic/adaptable libraries (with suitable interface code customizable to the platform). The Hybrid Technique described herein is applicable to all the Platforms/Radio Frequency Integrated Circuits (RFICs) that the OEMs utilize in their products.

Some embodiments of this current disclosure include a hybrid technique for risk mitigation of platform software migration. Some embodiments include a combination of techniques that enable OEMs to detect changes that impact third party driver code early using automated tools that run in the OEM environment. Early detection using automated tools and techniques offers OEMs risk mitigation and enables differentiation from competing RFFE vendors.

In some embodiments, the apparatus for these methods/techniques leverages various compilation and simulation tools of the platform and incorporates a unique and powerful framework. This provides capabilities that the platform tools do not provide alone.

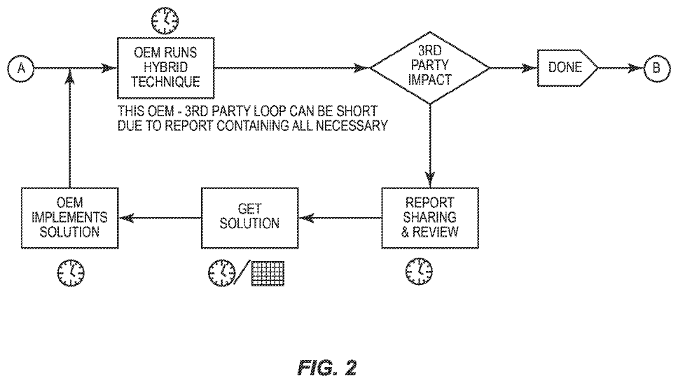

FIG. 2 illustrates the updated cycle using the disclosed methods. Now the OEM runs the hybrid technique to determine the third-party impact, according to some embodiments of the current disclosure. This enables report sharing and review that will allow any needed solutions to be obtained faster or avoided. In this embodiments, the OEM/third party loop can be short due to the report containing all necessary information.

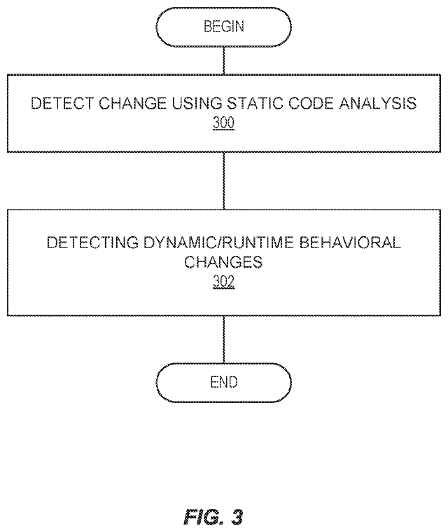

FIG. 3 illustrates an example embodiment for mitigating risk of platform software changes, according to some embodiments of the current disclosure. In some embodiments, the method consists of the following processes and techniques: detecting change using static code analysis (step 300); and detecting dynamic/runtime behavioral changes (step 302).

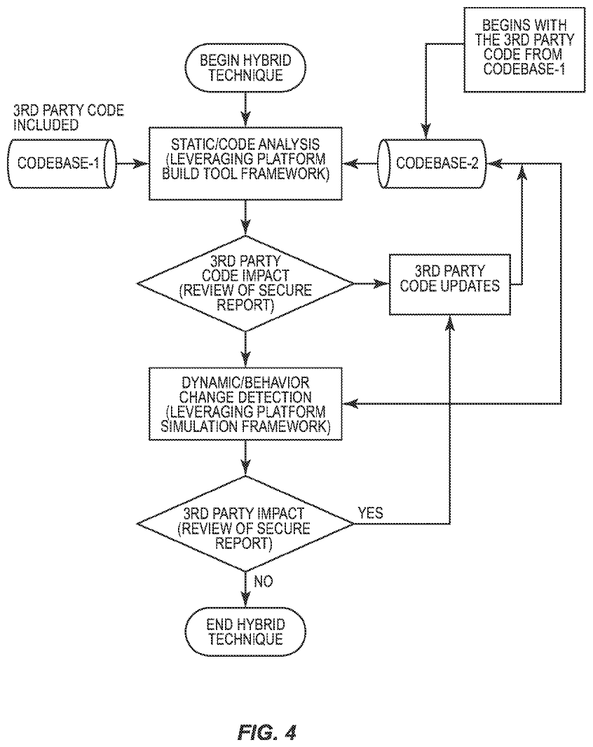

FIG. 4 illustrates additional details regarding the proposed methods, according to some embodiments of the current disclosure. In some embodiments, the static code analysis (step 300) involves comparison of any source code released by the Platform vendor to the OEM. The comparison analyzes source code files and libraries of interest with a focus on structure and other data types, function signatures, class definitions, etc. between the old and new codebases. In some embodiments, this analysis is automated. The Codebase releases (i.e., from Platform vendors) contain a mixture of source code and libraries. The header files corresponding to many classes in the libraries are not published. This can make the static code analysis more complex. In some embodiments, this is accomplished by using a combination of several different methods.

In some embodiments, the static code analysis (step 300) does not require the OEM/Customer to purchase or license any other off the shelf products or tools. Instead, the static code analysis leverages the generally available build tool framework of the platform.

In some embodiments, by targeting a few source files and libraries for comparison of data types and functions of interest, a secure and/or encrypted report is generated. In some embodiments, this report highlights the differences between codebases.

Receiving the report encrypted and/or encoded enables a competitive advantage over other RFFE vendors. In some embodiments, the customer/OEM does not have to share the full source files of the platform with the third party for the third party to update the code.

This enables the RFFE vendor to make any updates to their interface code. Updating the interface code helps solve any compile/link time error due to migration to the new Platform codebase. In some embodiments, “Self-healing” can be provided for a variety of issues that can occur during Software integration. For instance, if the static code analysis (step 300) indicates a type mismatch, a version of the code can be tested with the variable type automatically corrected to match.

In some embodiments, the static code analysis is captured in the form of a binary/executable to be used by the Customer/OEM in their platform build environment. In some embodiments, the Customer/OEM can run the static code analysis part of the automated method/tool as soon as they are ready to integrate the new Platform codebase. This process can be seamlessly integrated into Customer/OEM workflow without additional support.

In some embodiments, the dynamic/runtime behavioral change detection step (step 302) is run in two steps. Using the simulator capabilities of the platforms, techniques are developed, and test cases are targeted to exercise libraries and source code of interest to specific RFFE components. The first step of the dynamic/runtime behavioral change detection step is exercised on the existing codebase and the results are captured.

This exercise does not need any specific hardware since this can be accomplished with the simulator capabilities of the platforms. In some embodiments, the proposed method/apparatus runs on the OEM's code build computer. In some embodiments, the dynamic/runtime behavior analysis does not require the Customer/OEM to purchase or license any other off the shelf products.

The second step of the dynamic/runtime behavioral change detection step (step 302) is exercised with the new codebase. If the static code analysis (step 300) does not show any changes that impact the RFFE interface code or libraries; or the RFFE addresses the identified changes.

A comparison of the results of the two runs of dynamic behavior is recorded in a report to be analyzed by the RFFE vendor. In some embodiments, the report is secure and/or encrypted. This security and/or encryption enables a competitive advantage over other RFFE vendors.

In some embodiments, the dynamic/behavioral analysis technique/method is captured in the form of a binary/executable to be used by the Customer/OEM in their platform build environment.

In some embodiments, the customer/OEM is able to exercise the Dynamic/Runtime behavioral detection method/tool without support long before the Hardware is ready. As with the Static Analysis, this method/tool can easily be integrated into the Customer/OEM new Codebase migration workflow without needing any support from the RFFE vendor.

In some embodiments, the proposed suite of tools runs in a Customer build environment where platform code, OEM code, and third party code are integrated for the final modern image. The tool suite might leave a signature/marker in the relevant code that goes into the modern image/binary on the handset. This can aid detectability and with additional debugging.

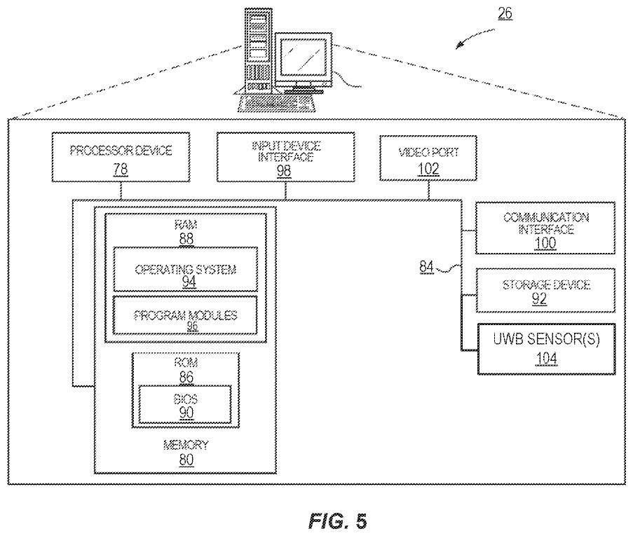

FIG. 5 is a block diagram of system 26 suitable for implementing examples according to one example. The system 26 may comprise any computing or electronic device capable of including firmware, hardware, and/or executing software instructions to implement the functionality described herein, such as a computer server, a desktop computing device, a laptop computing device, a smartphone, a computing tablet, or the like. The system 26 includes the processor device 78, the system memory 80, and a system bus 84. The system memory 80 may include non-volatile memory 86 and volatile memory 88. The non-volatile memory 86 may include read-only memory (ROM), erasable programmable read-only memory (EPROM), electrically erasable programmable read-only memory (EEPROM), and the like. The volatile memory 88 generally includes random-access memory (RAM)). A basic input/output system (BIOS) 90 may be stored in the non-volatile memory 86 and can include the basic routines that help to transfer information between elements within the system 26.

The system bus 84 provides an interface for system components including, but not limited to, the system memory 80 and the processor device 78. The system bus 84 may be any of several types of bus structures that may further interconnect to a memory bus (with or without a memory controller), a peripheral bus, and/or a local bus using any of a variety of commercially available bus architectures. The processor device 78 can be any commercially available or proprietary processor, central processing unit (CPU), microcontroller, or the like.

The system 26 may further include or be coupled to a non-transitory computer-readable storage medium, such as the storage device 92, which may represent an internal or external hard disk drive (HDD), flash memory, or the like. The storage device 92 and other drives associated with computer-readable media and computer-usable media may provide non-volatile storage of data, data structures, computer-executable instructions, and the like. Although the description of computer-readable media above refers to an HDD, it should be appreciated that other types of media that are readable by a computer, such as optical disks, magnetic cassettes, flash memory cards, cartridges, and the like, may also be used in the operating environment, and, further, that any such media may contain computer-executable instructions for performing novel methods of the disclosed embodiments.

An operating system 94 and any number of applications 96 can be stored in the volatile memory 88, wherein the applications 96 represent a wide array of computer-executable instructions corresponding to programs, applications, functions, and the like that may implement the functionality described herein in whole or in part. The applications 96 may also reside on the storage mechanism provided by the storage device 92. As such, all or a portion of the functionality described herein may be implemented as a computer program product stored on a transitory or non-transitory computer-usable or computer-readable storage medium, such as the storage device 92, volatile memory 88, non-volatile memory 86, and the like. The computer program product includes complex programming instructions, such as complex computer-readable program code, to cause the processor device 78 to carry out the steps necessary to implement the functions described herein. The processor device 78, may serve as a controller or control system for the system 26 to implement the functionality described herein based on the computer program product.

An operator, such as the user, may also be able to enter one or more configuration commands through a keyboard, a pointing device such as a mouse, or a touch-sensitive surface, such as the display device, via an input device interface 98 or remotely through a web interface, terminal program, or the like via a communication interface 100. The display device, which is coupled to the system bus 84, may be driven via a video port 102. The communication interface 100 may be wired or wireless and facilitate communications with any number of devices in a direct or indirect fashion. In some embodiments, there are also one or more Ultra-Wideband (UWB) sensors 104.

Those skilled in the art will recognize improvements and modifications to the preferred embodiments of the present disclosure. All such improvements and modifications are considered within the scope of the concepts disclosed herein and the claims that follow.

1. A method for mitigating risk of platform software changes, the method comprising:
detecting a change using static code analysis; and
detecting dynamic/runtime behavioral changes.

2. The method of claim 1 wherein detecting the dynamic/runtime behavioral changes comprises:
testing the dynamic/runtime behavioral changes based on the detected change using static code analysis.

3. The method of claim 1 wherein detecting the change using static code analysis comprises:
analyzing an existing codebase and capturing results;
analyzing an updated codebase and capturing results; and
comparing the captured results.

4. The method of claim 3 wherein the existing codebase and updated codebase comprise source code files and libraries of interest.

5. The method of claim 3 wherein comparing the captured results comprises a focus on one or more of: structure; data types; function signatures; and class definitions.

6. The method of claim 1 wherein the static code analysis leverages a generally available build tool framework of the platform.

7. The method of claim 1 wherein detecting the dynamic/runtime behavioral changes comprises:
exercising the existing codebase and capturing results;
exercising the updated codebase and capturing results; and
comparing the captured results.

8. The method of claim 1 wherein the method is performed in a customer build environment where platform code is integrated.

9. The method of claim 1 further comprising: preparing a report including information about the dynamic/runtime behavioral changes.

10. The method of claim 9 wherein the report including the information about the dynamic/runtime behavioral changes is encrypted.

11. The method of claim 9 wherein the report highlights the differences between the existing codebase and the updated codebase.

12. The method of claim 1 wherein the static code analysis is captured in the form of a binary/executable.

13. The method of claim 12 wherein the static code analysis can be used in the customer build environment.

14. The method of claim 1 further comprising: including a signature and/or marker in relevant code based on any code changes.

15. The method of claim 1 wherein the static code analysis does not require purchase and/or license of any other off the shelf products or tools.

16. The method of claim 1 wherein the static code analysis leverages the generally available build tool framework of the platform.

17. The method of claim 1 further comprising:
upon the static code analysis indicating a type mismatch, a version of the code is tested with a variable type automatically corrected to match.

18. The method of claim 17 further comprising:
upon the successful test of the version of the code with the variable type automatically corrected to match, changing the updated codebase to include the matching variable type.

19. The method of claim 1 wherein the software changes relate to Radio Frequency (RF) Front End (RFFE) components.
